(19) United States
(12) Patent Application Publication
(10) Pub. No.: US 2026/0004962 A1
(43) Pub. Date: Jan. 1, 2026

(54) METHODS OF FABRICATING COUPLED COAXIAL INDUCTORS IN PACKAGE STRUCTURES

(71) Applicant: Intel Corporation, Santa Clara, CA (US)

(72) Inventor: Mohamed R. Saber, College Station, TX (US)

(73) Assignee: Intel Corporation, Santa Clara, CA (US)

(21) Appl. No.: 18/757,265

(22) Filed: Jun. 27, 2024

(51) Int. Cl. H01F 27/28; H01F 27/24; H01F 27/29; H01F 41/02; H01F 41/04

(52) U.S. Cl. CPC H01F 27/2804; H01F 27/24; H01F 27/29; H01F 41/0206; H01F 41/04

(57) ABSTRACT

Microelectronic integrated circuit package structures include a package substrate with a core, and an inductor having a length extending vertically through the core. The inductor includes a magnetic material on a sidewall of the core, and a first conductive liner on a sidewall of the magnetic material, where a portion of the first conductive liner that is in a plane orthogonal to the length of the inductor comprises a first opening. A portion of a second conductive liner on the sidewall of the magnetic material that is in the plane comprises a second opening, where the first opening and the second opening face each other and are separated by a distance.

### BACKGROUND

In electronics manufacturing, integrated circuit (IC) packaging is a stage of manufacture where an IC that has been fabricated on a die or chip comprising a semiconducting material is coupled to a supporting case or “package” that can protect the IC from physical damage and support electrical interconnect suitable for further connecting to a host component, such as a printed circuit board (PCB). In the IC industry, the process of fabricating a package is often referred to as packaging, or assembly.

Enabling integrated power options in semiconductor packages requires inductor structures with high efficiency and low transient time. Utilizing coupled inductor structures can achieve such a combination. Coupled inductors have several advantages as compared to non-coupled inductors. For example, coupled inductors have a much lower self-flux leading to lower ripple and higher current ramp rate as compared with non-coupled inductors. However, coupled inductor design can be challenging due to alignment and filtering efficiency challenges.

### BRIEF DESCRIPTION OF THE DRAWINGS

The subject matter described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIGS. 1A-1B are cross-sectional views of IC package structures comprising coupling enhancement structures, in accordance with some embodiments.

FIG. 1C is a top view of IC package structures comprising coupled coaxial magnetic inductor (CMIL) structures, in accordance with some embodiments.

FIGS. 2A-2G are top views of IC package structures comprising coupled CMIL inductor structures, in accordance with some embodiments.

FIG. 2H is a cross-sectional view of IC package structures comprising coupled CMIL inductor structures, in accordance with some embodiments.

FIGS. 3A-3H are top views of IC package structures comprising methods of forming coupled CMIL inductor structures, in accordance with some embodiments.

FIGS. 4A-4G are cross-sectional views of IC package structures comprising forming coupled CMIL inductor structures, in accordance with some embodiments.

FIG. 5 is a cross-sectional view of an IC package structure comprising coupled CMIL inductor structures, in accordance with some embodiments.

FIG. 6A-6B illustrate flow charts of processes for the fabrication of IC package structures having coupled CMIL inductor structures, in accordance with some embodiments.

FIG. 7 is a functional block diagram of an electronic computing device, in accordance with some embodiments of the present disclosure.

### DETAILED DESCRIPTION

Embodiments are described with reference to the enclosed figures. While specific configurations and arrangements are depicted and discussed in detail, it should be understood that this is done for illustrative purposes only. Persons skilled in the relevant art will recognize that other configurations and arrangements are possible without departing from the spirit and scope of the description. It will be apparent to those skilled in the relevant art that techniques and/or arrangements described herein may be employed in a variety of other systems and applications other than what is described in detail herein.

Reference is made in the following detailed description to the accompanying drawings, which form a part hereof and illustrate exemplary embodiments. Further, it is to be understood that other embodiments may be utilized and structural and/or logical changes may be made without departing from the scope of claimed subject matter. It should also be noted that directions and references, for example, up, down, top, bottom, and so on, may be used merely to facilitate the description of features in the drawings. Therefore, the following detailed description is not to be taken in a limiting sense and the scope of claimed subject matter is defined solely by the appended claims and their equivalents.

In the following description, numerous details are set forth. However, it will be apparent to one skilled in the art, that embodiments may be practiced without these specific details. In some instances, well-known methods and devices are shown in block diagram form, rather than in detail, to avoid obscuring the embodiments. Reference throughout this specification to “an embodiment” or “one embodiment” or “some embodiments” means that a particular feature, structure, function, or characteristic described in connection with the embodiment is included in at least one embodiment. Thus, the appearances of the phrase “in an embodiment” or “in one embodiment” or “some embodiments” in various places throughout this specification are not necessarily referring to the same embodiment. Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items.

The terms “coupled” and “connected,” along with their derivatives, may be used herein to describe functional or structural relationships between components. It should be understood that these terms are not intended as synonyms for each other. Rather, in particular embodiments, “connected” may be used to indicate that two or more elements are in direct physical, optical, or electrical contact with each other. “Coupled” may be used to indicated that two or more elements are in either direct or indirect (with other intervening elements between them) physical or electrical contact with each other, and/or that the two or more elements co-operate or interact with each other (e.g., as in a cause and effect relationship).

The terms “over,” “under,” “between,” and “on” as used herein refer to a relative position of one component or material with respect to other components or materials where such physical relationships are noteworthy. For example in the context of materials, one material or layer over or under another may be directly in contact or may have one or more intervening materials or layers. Moreover, one material between two materials or layers may be directly in contact with the two materials/layers or may have one or more intervening materials/layers. In contrast, a first material or layer “on” a second material or layer is in direct physical contact with that second material/layer. Similar distinctions are to be made in the context of component assemblies.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C.

Unless otherwise specified in the explicit context of use, the term “predominantly” means more than 50%, or more than half. For example, a composition that is predominantly a first constituent means more than half of the composition is the first constituent (e.g., <50 at. %). The term “primarily” means the most, or greatest, part. For example, a composition that is primarily a first constituent means the composition has more of the first constituent than any other constituent.

The term “package” generally refers to a self-contained carrier of one or more dice, where the dice are attached to the package substrate, and may be encapsulated for protection, with integrated or wire-bonded interconnects between the dice and leads, pins or bumps located on the external portions of the package substrate. The package may contain a single die, or multiple dice, providing a specific function. The package is usually mounted on a printed circuit board for interconnection with other packaged integrated circuits and discrete components, forming a larger circuit.

The term “dielectric” generally refers to any number of non-electrically conductive materials that make up the structure of a package substrate.

The term “metallization” generally refers to metal layers formed over and through the dielectric material of the package substrate. The metal layers are generally patterned to form metal structures such as traces and bond pads. The metallization of a package substrate may be confined to a single layer or in multiple layers separated by layers of dielectric.

The term “bond pad” generally refers to metallization structures that terminate integrated traces and vias in integrated circuit packages and dies. The term “solder pad” may be occasionally substituted for “bond pad” and carries the same meaning.

The term “solder bump” generally refers to a solder layer formed on a bond pad. The solder layer typically has a round shape, hence the term “solder bump”.

The term “substrate” generally refers to a planar platform comprising dielectric and metallization structures. The substrate mechanically supports and electrically couples one or more IC dies on a single platform, with encapsulation of the one or more IC dies by a moldable dielectric material. The substrate generally comprises solder bumps as bonding interconnects on both sides. One side of the substrate, generally referred to as the “die side”, comprises solder bumps for chip or die bonding. The opposite side of the substrate, generally referred to as the “land side”, comprises solder bumps for bonding the package to a printed circuit board.

The vertical orientation is in the z-direction and it is understood that recitations of “top”, “bottom”, “above” and “below” refer to relative positions in the z-dimension with the usual meaning. However, it is understood that embodiments are not necessarily limited to the orientations or configurations illustrated in the figure.

The terms “substantially,” “close,” “approximately,” “near,” and “about,” generally refer to being within +/−10% of a target value (unless specifically specified). Unless otherwise specified the use of the ordinal adjectives “first,” “second,” and “third,” etc., to describe a common object, merely indicate that different instances of like objects to which are being referred and are not intended to imply that the objects so described must be in a given sequence, either temporally, spatially, in ranking or in any other manner.

Views labeled “cross-sectional”, “profile” and “plan” correspond to orthogonal planes within a Cartesian coordinate system. Thus, cross-sectional and profile views are taken in the x-z plane, and plan views are taken in the x-y plane. Typically, profile views in the x-z plane are cross-sectional views. Where appropriate, drawings are labeled with axes to indicate the orientation of the figure.

Embodiments discussed herein address problems associated with packaging architectures and methods of providing inductor structures for enabling integrated power options on semiconductor packages architectures with high efficiency and low transient time. For example, packaged inductor structures may be employed with voltage regulators, such as fully integrated voltage regulators (FIVR) for voltage power regulation. The embodiments described herein enable higher efficiency FIVR circuits. The embodiments further provide inductor fabrication methods requiring a reduced number of process steps thus reducing fabrication cost.

Achieving high efficiency and low transient time can be realized by employing coupled inductor structures. Coupled inductors have several advantages as compared to noncoupled inductors. For example, coupled inductors have a much lower self-flux leading to a lower ripple and a higher current ramp rate as compared with non-coupled inductors. Currently, fabricating coupled inductor design is challenging due to alignment challenges and reduced filtering efficiency.

The embodiments herein include semiconductor package structures with a coupled coaxial magnetic inductor layer (CMIL) in a core layer of the package structure/device. The coupled CMIL coupled inductor structures may include a copper lined plated through hole (TH) in the center of a larger diameter TH that is filled with a high permeability magnetic material such as a magnetic resin, a magnetic paste or a magnetic thin film. Embodiments describe methods of fabricating package structures having coupled inductor structures to enable smaller plated through hole (PTH) pitch and hence enables 100 micron TH wall to wall distance resulting in stronger magnetic coupling.

In an embodiment, a core of a package substrate has a coupled CMIL inductor extending within the core. The inductor has a length extending vertically through the core. The inductor comprises a first sidewall of a magnetic material on a sidewall of the core. A conductive liner is on a second sidewall of the magnetic material, wherein a first portion of the conductive liner that is in a plane orthogonal to the length of the inductor comprises a first opening. A second portion of the conductive liner that is in the orthogonal plane comprises a second opening, wherein the first opening and the second opening face each other and are separated by a distance. A non-magnetic material is between the first and second portions of the conductive liner.

In another embodiment, a coupled CMIL inductor extends within the core of a package structure. The inductor comprises a first sidewall of a magnetic material on a sidewall of the core. A conductive liner is on a second sidewall of the magnetic material, wherein a first portion of the conductive liner that is in a plane orthogonal to the length of the inductor comprises a first opening. A second portion of the conductive liner that is in the orthogonal plane comprises a second opening, wherein the first opening and the second opening face each other and are separated by a distance. A groove is between the first opening and the second opening. A non-magnetic material is between the first and second portions of the conductive liner, wherein a portion of the non-magnetic material extends beyond terminal sidewalls of the first opening and the second opening.

The architecture described herein may be assembled and/or fabricated with one or more of the features or attributes provided in accordance with various embodiments. A number of different assembly and/or fabrication methods may be practiced to enable the formation of coupled CMIL inductor design with tighter design specifications and stronger magnetic coupling which reduce self-flux and increase current ramp rate of such package systems, according to one or more of the features or attributes described herein.

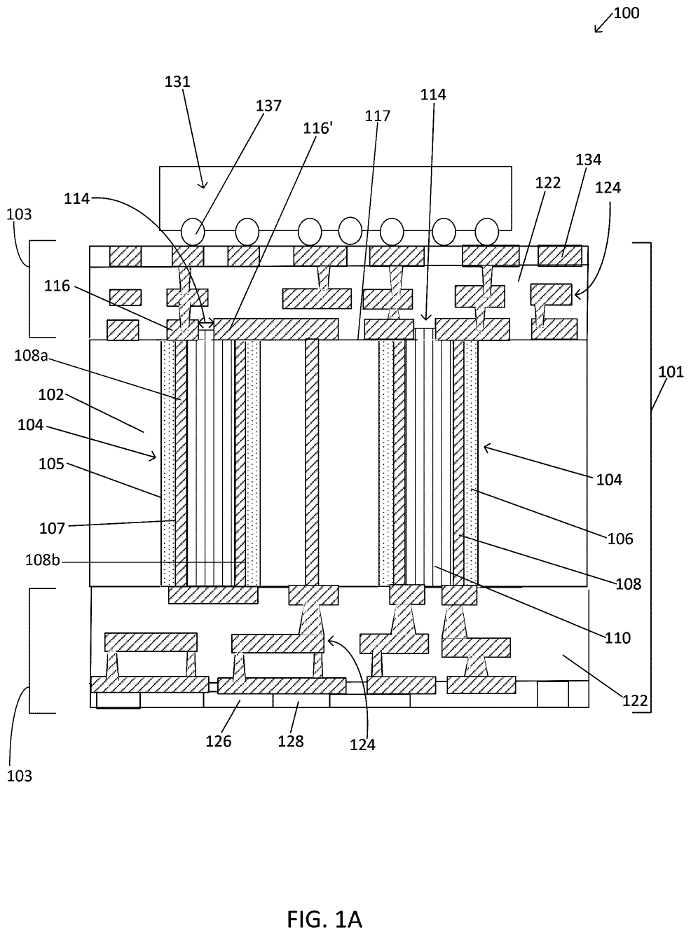

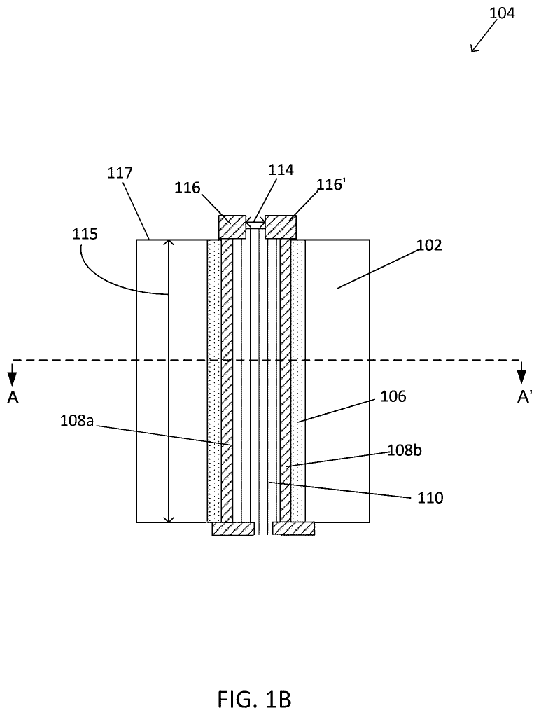

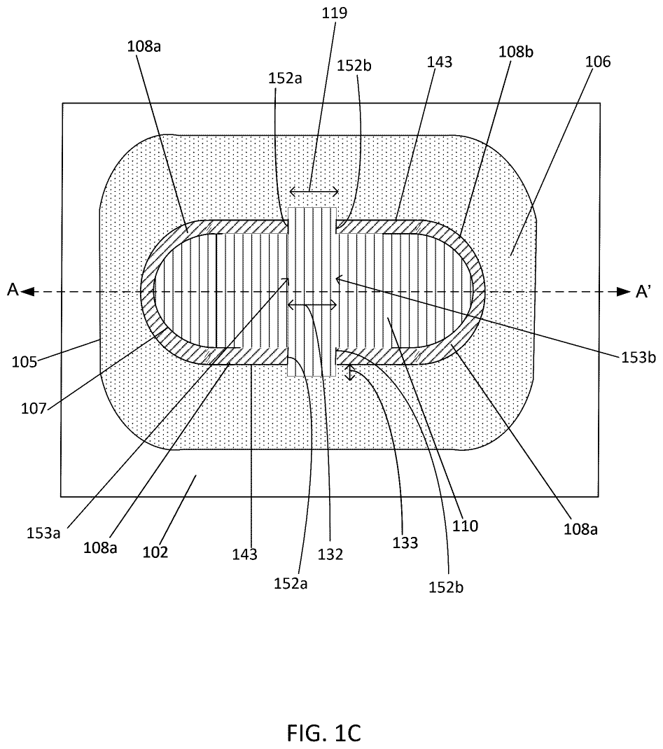

FIGS. 1A-1C illustrate embodiments of package structures including coupled CMIL inductor design. The package structures are formed utilizing standard IC processing techniques. The methods of fabrication described herein create improved device performance in advanced 2.5D and 3D packaging.

FIG. 1A is a cross-sectional view of a portion of integrated circuit (IC) package structure 100 comprising a coupled CMIL structure inductor 104, in accordance with some embodiments. As shown, a package substrate 101 may comprise a core portion 102 with build up layer portions 103 on the core 102. The package substrate 101 may comprise an organic substrate or any other suitable material and may have a thickness of between about 100 microns to 3 mm. The package substrate 101 may provide mechanical support and electrical connectivity for die 131, such as logic die that may be attached to the package substrate 101. The package substrate 101 may comprise an interposer or a board in an embodiment. In some embodiments, the package substrate 101 may comprise materials such as dielectric materials, epoxy, glass or glass fibers, and or the like.

In some embodiments, build up layers 103 may be on top surface and/or bottom surfaces of the package substrate 101. Build up layers 103 may comprise a multiple-layer stack of overlaid sheets of laminated film (e.g., build-up film). Build up layers 103 materials may include composite epoxies, liquid crystalline polymers and polyimides. Other suitable materials may be employed. In some embodiments, build up layers 103 are a monolithic block rather than laminated film. Suitable organic or inorganic materials may be employed. Build up layers 103 may include such materials as FR4 (e.g., epoxy-based laminate), bismaleimide-triaxine, polyimide, silicon, or epoxy resin.

One or more inductor structures 104 may be within the core material 102. Inductor structures 104 may comprise a coupled CMIL inductor structure 104 and may comprise a first sidewall 105 of the magnetic material 106 on the core 102, with a conductive liner 108 on a second sidewall 107 of the magnetic material 106. A non-magnetic material 110 may be on the conductive liner 108.

A die 131 may be on the package substrate 101, wherein the die 131 may comprise a central processing unit (CPU) or a field programmable gate array (FPGA) die, or FIVR circuitry, for example or may comprise any suitable logic die for the particular application. The die 131 may be bonded to the package substrate 101 and the one or more inductors 104 via solder structures 137 coupled to conductive contact structures 134.

The build up layer 103 may include a dielectric material 122 with conductive traces 124 located throughout which may couple another substrate or die, such as die 131, to the inductor 104 within the package substrate 101. The conductive traces 124 may comprise copper or copper alloys in an embodiment. A passivation material 126 may be on a surface of the build-up dielectric material 122. The passivation material 126 may comprise such materials as silicon nitride and the like and may be adjacent to board contact pads 128.

The magnetic material 106 may comprise any suitable thickness or materials which may include, but are not limited to, any of iron, nickel, nickel-iron alloys such as Mu metals and/or permalloys. In some embodiments, magnetic materials comprise lanthanide and/or actinide elements. In some embodiments, magnetic materials 106 comprise cobalt-zirconium-tantalum alloy (e.g., CZT). Suitable magnetic materials may also comprise semiconducting or semi-metallic Heusler compounds and non-conducting (ceramic) ferrites. In some embodiments, ferrite materials comprise any of nickel, manganese, zinc, and/or cobalt cations, in addition to iron. In some embodiments, ferrite materials comprise barium and/or strontium cations. Heusler compounds may comprise any of manganese, iron, cobalt, molybdenum, nickel, copper, vanadium, indium, aluminum, gallium, silicon, germanium, tin, and/or antimony. Heusler alloy, Co, Fe, Ni, Gd, B, Ge, Ga, permalloy, or yttrium iron garnet (YIG), and wherein the Heusler alloy is a material which includes one or more of: Cu, Mn, Al, In, Sn, Ni, Sb, Ga, Co, Fe, Si, Pd, Sb, V, Ru, Cu2MnAl, Cu2MnIn, Cu2MnSn, Ni2MnAl, Ni2MnIn, Ni2MnSn, Ni2MnSb, Ni2MnGa Co2MnAl, Co2MnSi, Co2MnGa, Co2MnGe, Pd2MnAl, Pd2MnIn, Pd2MnSn, Pd2MnSb, Co2FeSi, Co2FeAl, Fe2VAl, Mn2VGa, Co2FeGe, MnGa, MnGaRu, or Mn3X, where ‘X’ is one of Ga or Ge.

Magnetic materials such as Pt, Pd, W, Ce, Al, Li, Mg, Na, Cr2O3, CoO, Dy, Dy2O, Er, Er2O3, Eu, Eu2O3, Gd, Gd2O3, FeO, Fe2O3, Nd, Nd2O3, KO2, Pr, Sm, Sm2O3, Tb, Tb2O3, Tm, Tm2O3, V, V2O3 or epoxy material with particles of a magnetic alloy may be utilized, or magnetic alloys can be an alloy formed of one or more of: Pt, Pd, W, Ce, Al, Li, Mg, Na, Cr, Co, Dy, Er, Eu, Gd, Fe, Nd, K, Pr, Sm, Tb, Tm, or V. While some of the magnetic materials are conductors, it is understood that the composite is electrically non-conductive to avoid short-circuiting the conductive liner 108. In an embodiment, the magnetic material 106 may comprise a thickness of 200-300 microns.

At least a portion of the conductive liner 108 is between the magnetic material 106 and a non-magnetic material 110, in an embodiment. In an embodiment, the conductive liner 108 may comprise any suitable conductive material, such as copper and or copper alloys and may comprise of thickness of about 50 microns or less. In an embodiment, the non-magnetic material 110 may comprise a dielectric material or a non-magnetic paste. In an embodiment, the non-magnetic material 110 comprises a silicate-based glass, a composite polymer and inorganic fill such as a fiberglass or a polycrystalline ceramic material or may comprise the same material as the core 102. In an embodiment, the non-magnetic material may comprise any suitable insulating plugging material.

In an embodiment, the non-magnetic material 110 may comprise a width of about 150 microns or less. In an embodiment, the non-magnetic material 110 may comprise a lateral width of between about 80 microns to about 150 microns. In an embodiment, a first pad 116 and a second pad 116′ are on a top surface 117 of the core 102. The first and second pads 116, 116′ may comprise copper or copper alloys in an embodiment. The first and second pads 116, 116′ may be coupled to a first portion of the conductive liner 108a and a second portion of the conductive liner 108b respectively. A distance 114 is between the first and second pads 116, 116′. In an embodiment, the distance 114 may be from about 40 microns to about 70 microns.

FIG. 1B is a cross-sectional view of a portion of a coupled CMIL inductor, such as inductor 104 of IC package structure 100 of FIG. 1A, in accordance with some embodiments. As shown, inductor 104 may comprise a magnetic material 106 on core 102, conductive liner 108 on the magnetic material 106, with non-magnetic material 110 at least partially surrounded by the conductive liner 108. First pad 116 is on a first portion of the conductive liner 108a, while second pad 116′ is on a second portion of the conductive liner 108b. A distance 114 separates first pad 116 from second pad 116′. In an embodiment, the inductor 104 comprises a length 115, wherein the length may be substantially equal to a length of the core 102.

A top view of FIG. 1B is taken from cut A-A′ across inductor 104 and is shown in FIG. 1C. In FIG. 1C, first sidewall 105 of magnetic material 106 is on the core 102 and second sidewall 107 of magnetic material 106 is on the first and second portions 108a, 108b of the conductive liner 108. A first portion 108a of the conductive liner 108 comprises a first opening 153a and a second portion 108b of the conductive liner 108 comprises a second opening 153b. In an embodiment, the first portion 108a and the second portion 108b comprise a semicircle or a semi-oval shape. In an embodiment, a terminal end/sidewall 152a of the first portion of the conductive liner 108a and a terminal end/sidewall 152b of the second portion 108b of the conductive liner comprise a distance 119 between them.

A groove 132 is between the first portion of the conductive liner 108a and the second portion 108b of the conductive liner. In an embodiment, the distance 119 is about 100 microns or less. In an embodiment, the first opening 153a faces the second opening 153a in the plane that is orthogonal to the length 115 of the inductor 104. In an embodiment, a portion 133 of the non-magnetic material 110 may extend beyond outer sidewalls 143 of the first portion of the conductive liner 108a and beyond outer sidewalls 143 of the second portion of the conductive liner 108b. In an embodiment, the portion 133 of the non-magnetic material 110 extends into a portion of the magnetic material 106. The coupled CMIL inductor design of the embodiments herein provides for a smaller PTH pitch of 150 microns or less, which produces a stronger magnetic coupling.

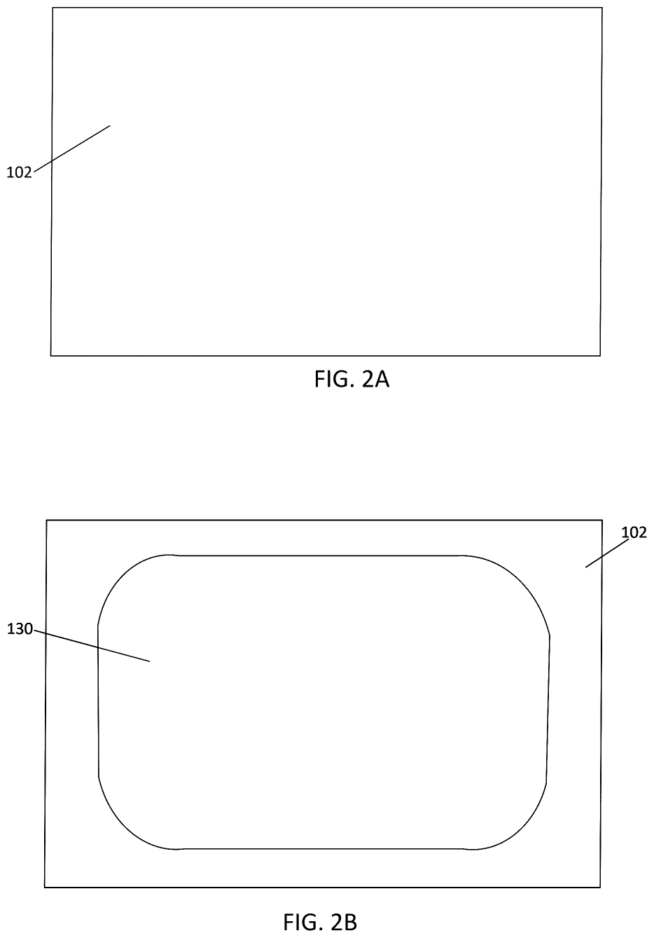

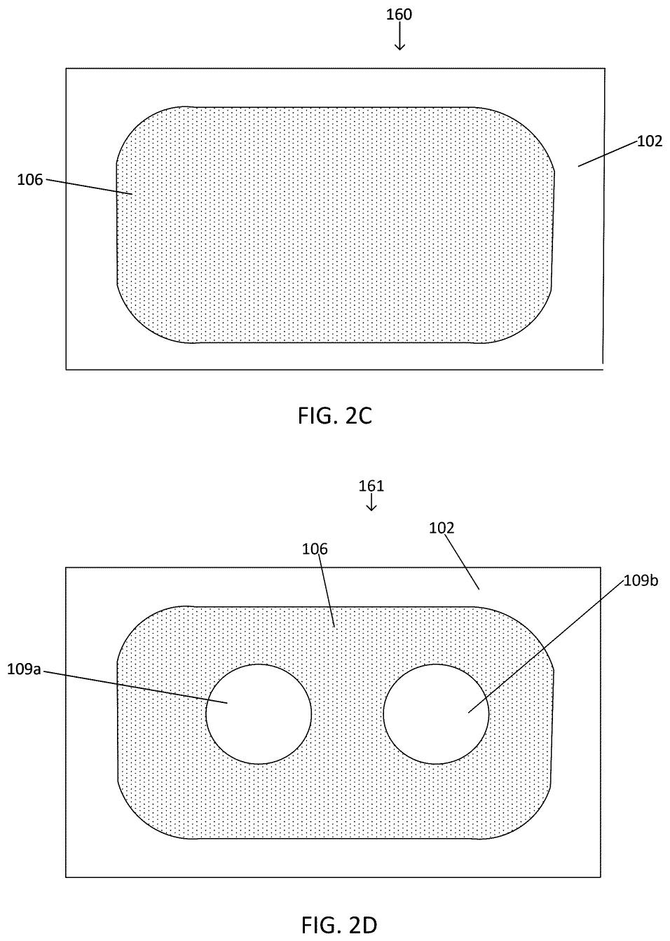

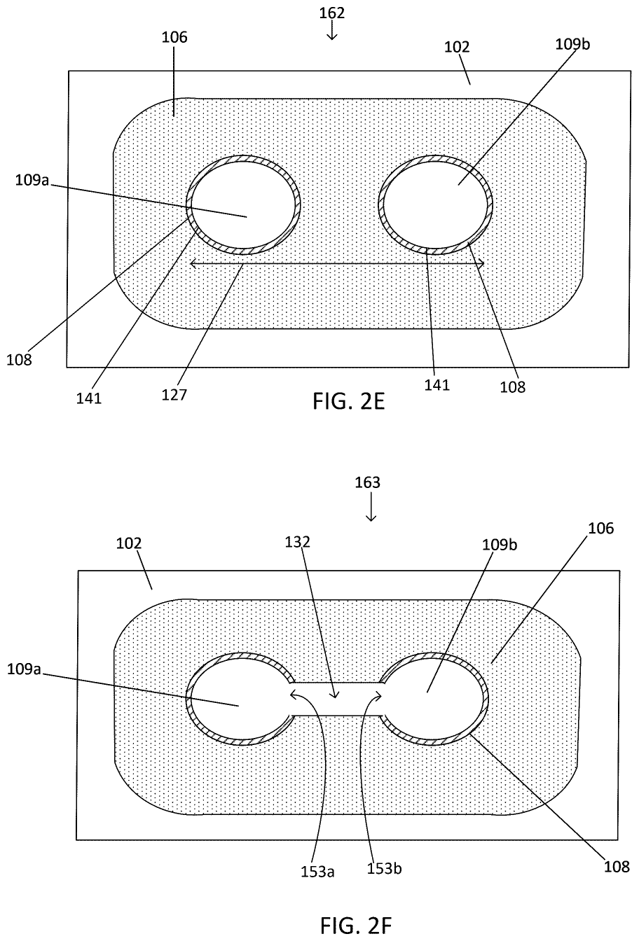

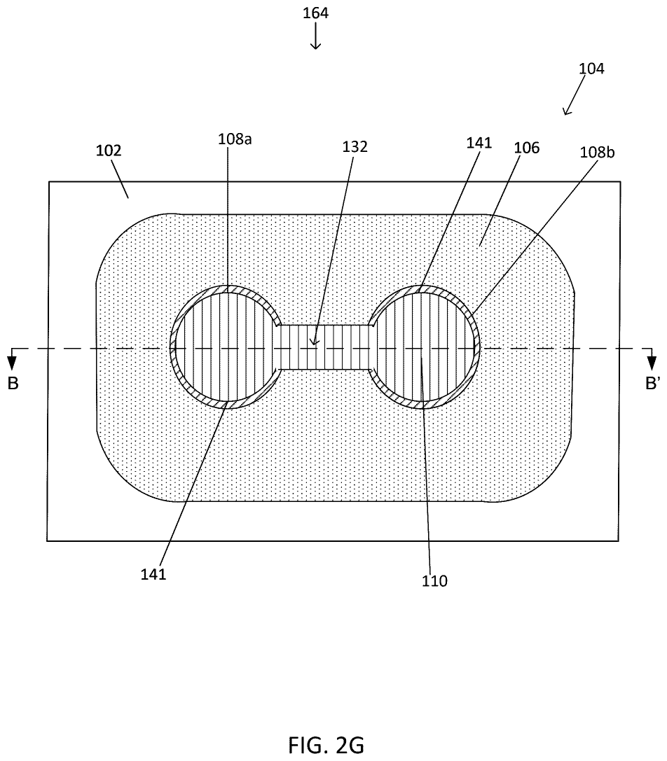

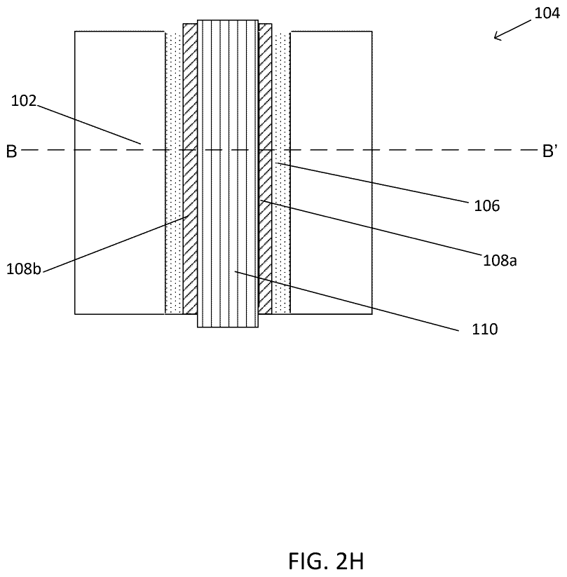

FIGS. 2A-2H illustrate embodiments of forming IC package structures (such as the IC package structures of FIGS. 1A-1C for example, comprising coupled CMIL inductors. FIG. 2A depicts a top view of a portion of a core 102 according to some embodiments. As shown the core 102 may comprise any suitable materials or combination of materials and provides a rigid mechanical support for the fabrication of a package substrate. The package core 102 formed by lamination of dielectric layers and of metallization structures as described above. In some embodiments, core 102 comprises materials such as, but not limited to, fiberglass-reinforced epoxy resins, glass, or polymer-ceramic composites.

In FIG. 2B, a top view of a core opening 130 is depicted, wherein the core opening 130 may be formed in the core 102. The core opening 130 may be formed by a routing or a drilling process for example. In an embodiment, the core opening 130 may comprise a core through-hole. In FIG. 2C, a magnetic material 106 may be formed utilizing a process 160 within the core opening 130. The magnetic material 106 may comprise any suitable magnetic material 106 with which to form one or more CMIL coupled inductors in the core 102. In some embodiments, magnetic material 106 comprises a magnetic material having a relative magnetic permeability between 5 and 50. In an embodiment, the magnetic material 106 may fill the core opening/core through hole 130 and maybe planarized thereafter by using a grinding process for example. In an embodiment, a top surface of the magnetic material 106 maybe coplanar with a top surface of the core 102.

The process 160 may comprise plugging/forming a magnetic paste into the core opening 102, in an embodiment. In some embodiments, the magnetic material may be formed within the core opening by dispensing a liquid or paste comprising magnetic particles suspended in a polymer matrix. In various embodiments, the polymer matrix comprises a curable epoxy resin. Other filling techniques may include filling the core opening with uncured magnetic core material include ink-jet printing. In some embodiments, a photo-patternable matrix material containing magnetic particles is deposited by spin coating or spray coating, and then patterned by lithographic techniques. The photo-patternable matrix may fill the core opening 102 and be patterned and cured.

FIG. 2D depicts a top view of a process 161 wherein two through holes 109a, 109b may be formed through the magnetic material 106. In an embodiment, the through holes 109a, 109b may be circular in shape. The through holes 109a, 109b may be formed by drilling through the magnetic material 106 in an embodiment. In an embodiment, the through holes 109a, 109b may comprise magnetic openings 109a,109b.

FIG. 2E depicts a process 162 wherein a conductive material 108 is formed within the through holes 109a, 109b to form plated through holes 109a, 109b. The conductive material 108 may comprise any suitable conductive materials such as copper or copper alloys, nickel, gold, silver, tungsten or molybdenum and may be formed utilizing a plating process. In an embodiment, the conductive material 108 may comprise a thickness of about 15 microns to about 30 microns. The conductive liner 108 is continuous layer within the PTH 109a, 109b. In an embodiment, a wall to wall pitch 127 between PTH 109a, 109b is 100 microns or less.

FIG. 2F depicts a top view of a process 163 wherein a groove 132 is formed between the PTHs 109a, 109b by utilizing a routing process for example. The formation of the groove 132 produces a semi-circular shape for the PTHs 109a, 109b, wherein openings 153a, 153b in the conductive liner 108 are formed. In an embodiment, openings 153a, 153b face each other. FIG. 2G depicts a top view of a process 164 wherein a non-magnetic material 110 may be formed between the PTH 109a, 109b and on inner sidewalls of the conductive liner 108a, 108b. In an embodiment, the non-magnetic material 110 may comprise a non-magnetic paste, or any suitable dielectric material.

A cross-sectional view as taken from cut B-B′ across inductor 104 of FIG. 2G is shown in FIG. 2H. Inductor 104 comprises the magnetic material 106 on the core 102. The first and second portions 108a, 108b of the conductive liner 108 are on the magnetic material 106, wherein the non-magnetic material 110 is within the plated through holes on the conductive liner 108. The non-magnetic material 110 is between the PTH 109a, 109b and on inner sidewalls of the conductive liner 108a, 108b.

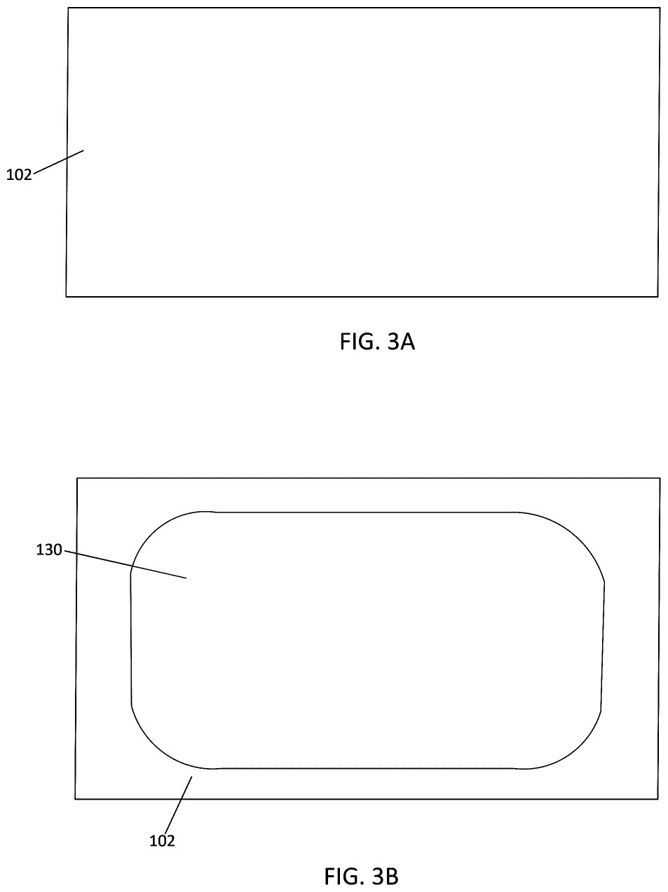

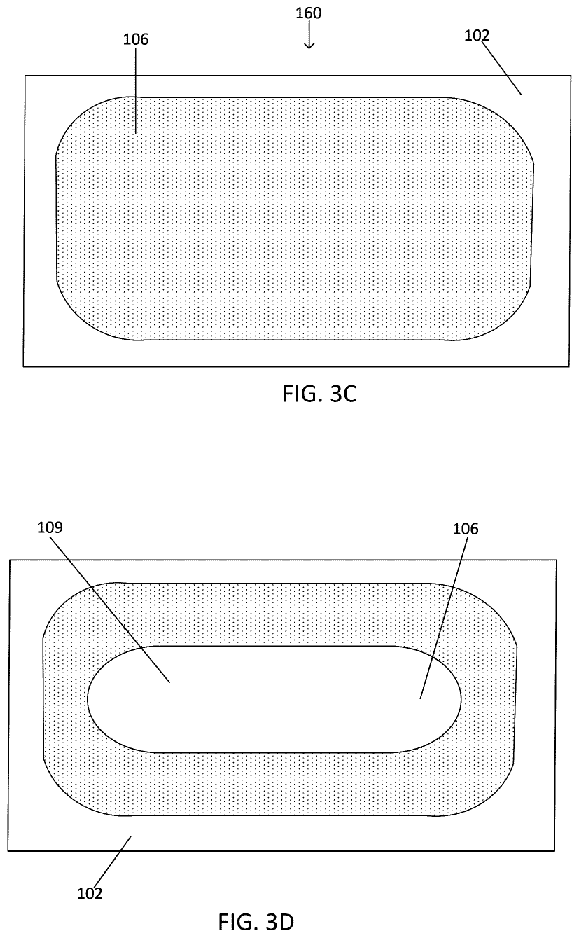

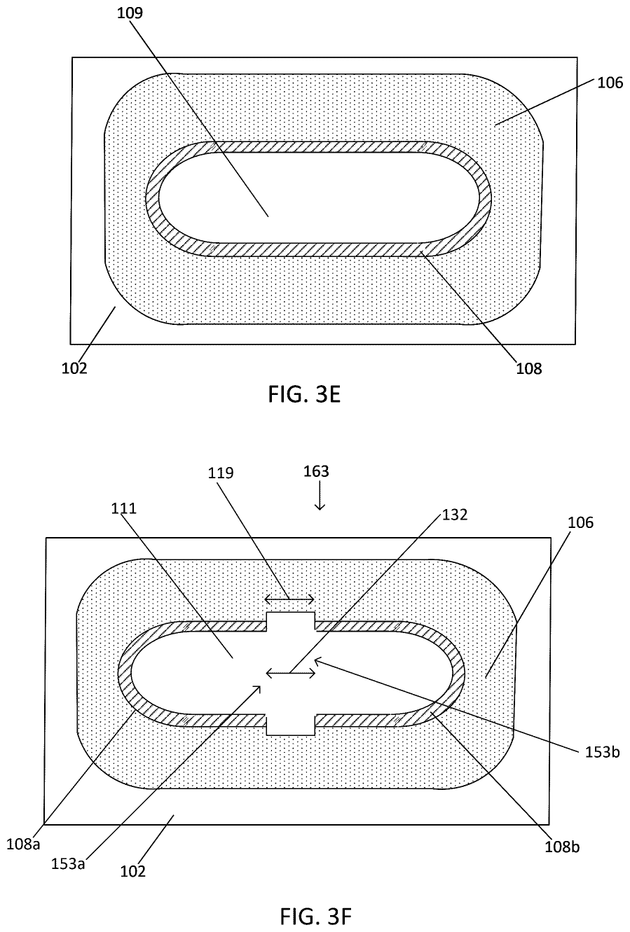

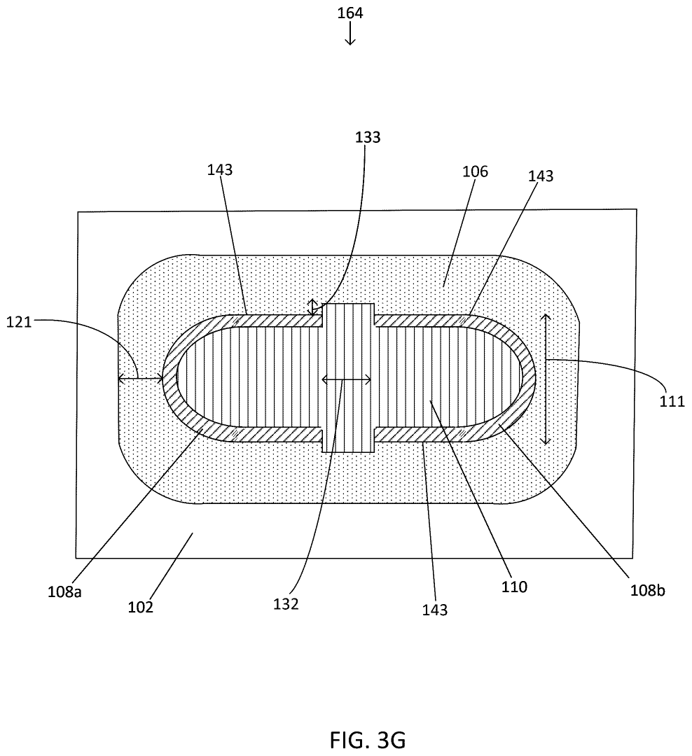

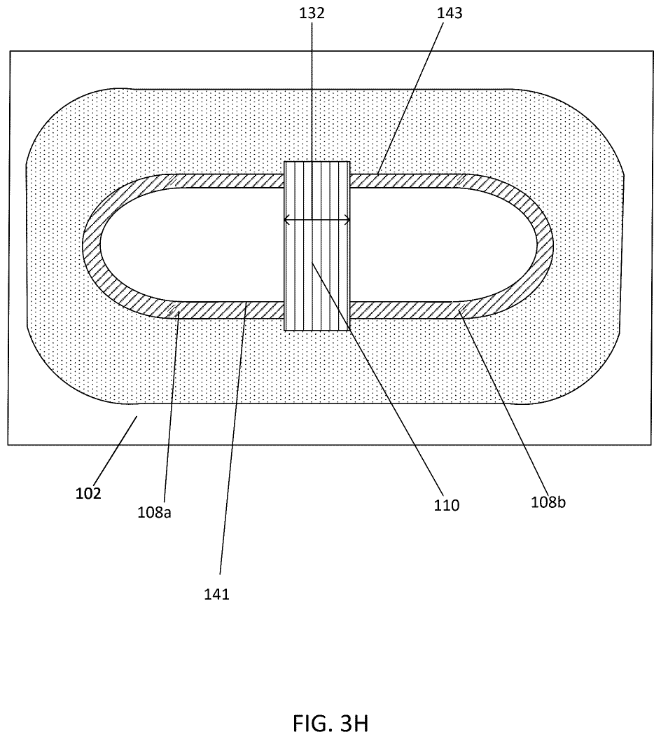

FIGS. 3A-3G depict a method of fabricating a package structure such as the package structure depicted in FIG. 1A for example. FIGS. 3A-3B depict a top view of the formation of core opening 130 in a portion of the core 102. The core 102 may comprise any suitable substrate with which to attach die and build a package structure thereupon. In an embodiment the core 102 may provide mechanical support and provide electrical communication within a package structure and between devices coupled with such a package structure.

In FIGS. 3C-3D depict a top view of a process 160 wherein a magnetic material 106 is formed within the core opening 130, and then a magnetic opening 109/through hole opening is formed within the magnetic material 106. A conductive liner 108 is formed on sidewalls of the magnetic material 106 (FIG. 3E), wherein the through hole opening 109 is lined by the conductive material 108 and may comprise a PTH 109. The conductive liner 108 is continuous layer within the PTH 109. In FIG. 3F, a routing process 163 may be performed wherein a groove 132 is formed in a central portion of the PTH 109 by utilizing a routing process for example, which may remove a portion of the conductive material 108 primarily in a central portion of the conductive layer. In an embodiment, a portion of the magnetic material 106 above the groove 132 may be removed. The formation of the groove 132 produces two semi-circular or horseshoe shapes for the PTH 109, wherein openings 153a, 153b in the two conductive liner portions 108a, 108b are formed. A distance 119 is between openings 153a, 153b. In an embodiment, openings 153a, 153b face each other. The groove 132 creates a coaxial structure for the inductor 104. The groove 132 extends a portion beyond outer sidewalls of the conductive liner 108 in an embodiment. A portion of the magnetic material 106 is removed by the process 163.

A non-magnetic material 110 is then formed on the inner sidewalls of the conductive liner portions 108a, 108b and within the groove 132 as depicted in FIG. 3G utilizing process 164. In an embodiment, a width 121 of the magnetic material 106 comprises between 100 microns to 160 microns and a distance 111 between outer sidewalls 143 of the second conductive portion 108b (and similarly for the first conductive portion 108a) comprises between about 100 microns to about 160 microns. A portion 133 of the non-magnetic material 110 is formed above the groove 132 and adjacent to outer sidewalls 143 of the conductive liner portions 108a, 108b. In another embodiment, the groove 132 is filled with the non-magnetic material 110, while at least a portion of the inner sidewalls 141 of the conductive material 108a, 108b are free of the non-magnetic material 110, as depicted in FIG. 3H.

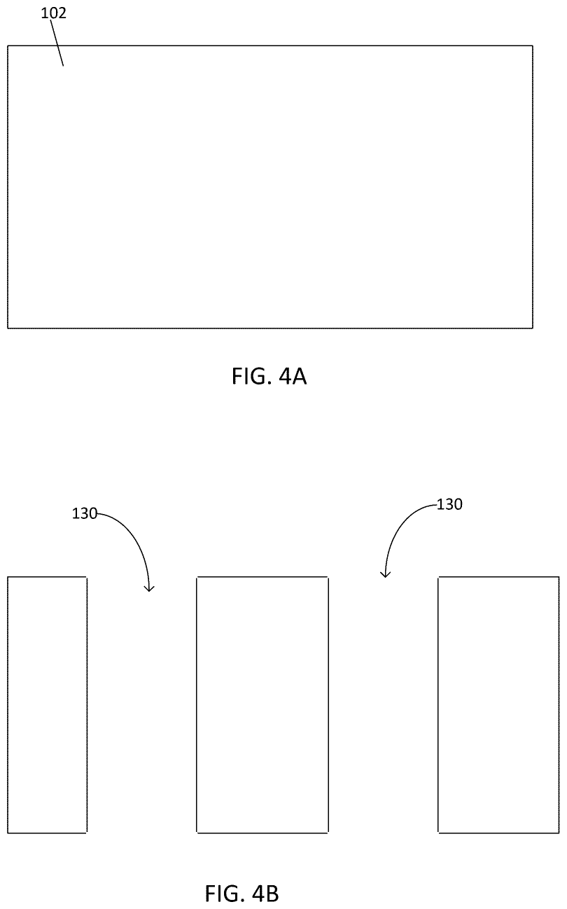

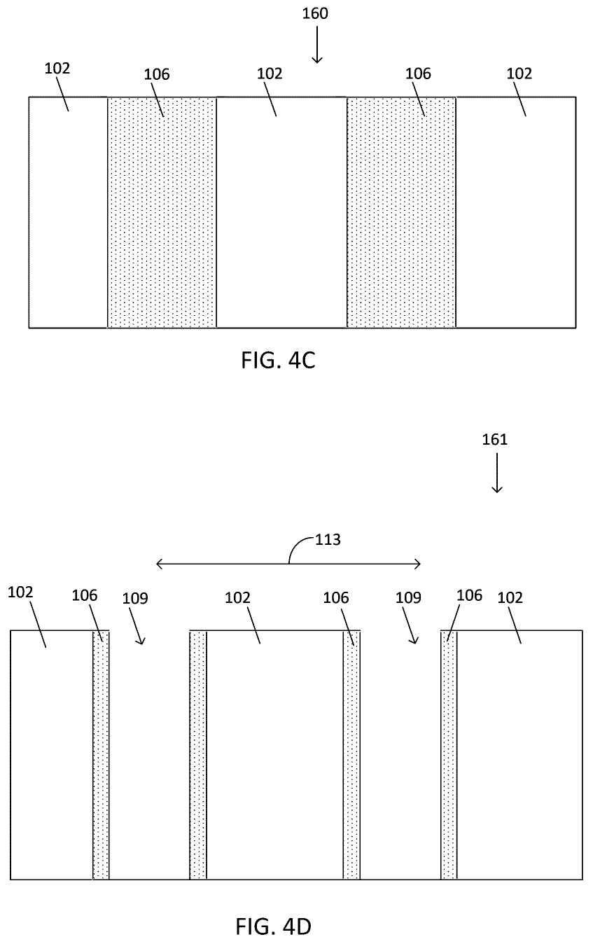

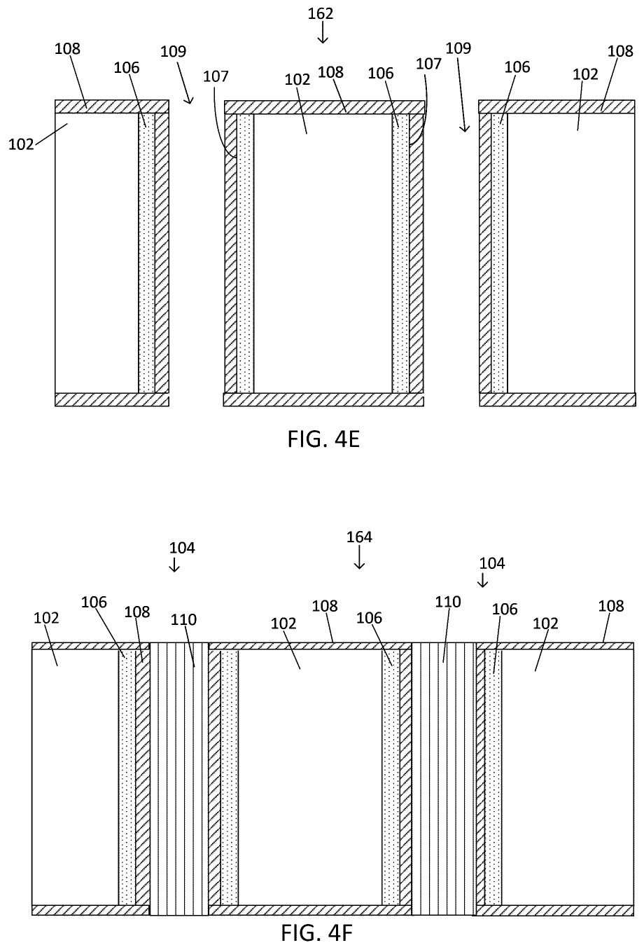

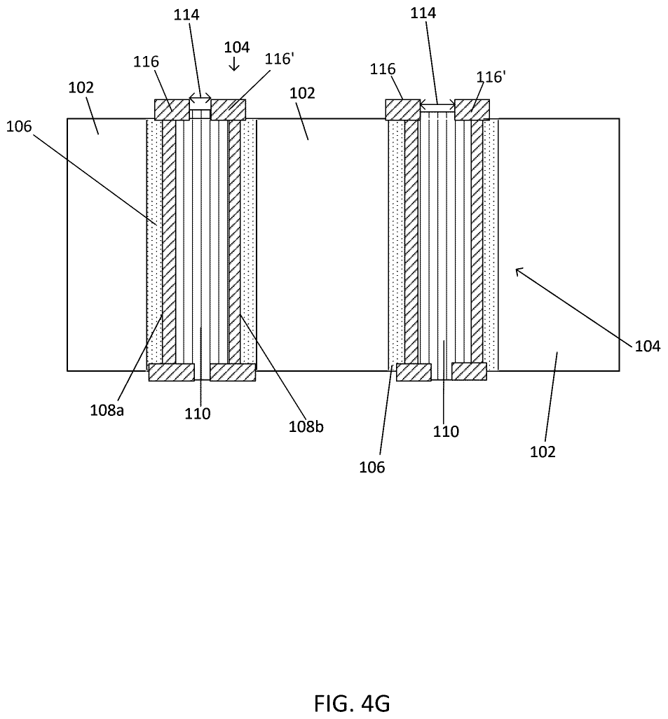

FIGS. 4A-4D depict cross sectional views of a method of fabricating a package structure having coupled CMIL inductors such as the package structures depicted in any of the previous Figures. FIG. 4A depicts a portion of a package core 102. The package core 102 may comprise any suitable substrate with which to attach die and build an optical package structure. In an embodiment the package substrate 101 may provide mechanical support and provide electrical communication within a package structure and between devices coupled with such a package structure. In an embodiment the package core 102 may comprise an interposer or a board.

In FIG. 4B openings 130 may be formed within the core 102. The openings 130 may comprise through hole openings 130 in an embodiment. In an embodiment the openings 130 maybe formed by using drilling and/or laser drilling processes for example. In FIG. 4C, a magnetic material 106 may be formed (utilizing process 160) within the core openings 130 on the core sidewalls. In an embodiment the magnetic material 106 may be formed by plugging the core openings with a magnetic paste. The magnetic paste may comprise a material with a relative magnetic permeability between 5 and 50. In an embodiment, the magnetic paste may comprise a magnetic powder, an epoxy resin, a reactive diluent, and a curing agent.

In FIG. 4D a process 161 may include the formation of openings 109 through the magnetic material 106. The openings 109 may be formed through the use of drilling processes or etching processes for example. The openings 109 extend through a length of the core 102. In an embodiment a pitch 113 between the openings 109 may comprise less than about 500 microns, but maybe optimized for a particular application. In an embodiment any number of openings 109 may be formed in the magnetic material 106 utilizing process 161.

In FIG. 4E a process 162 may be utilized to form a conductive liner 108 on sidewalls 107 of the magnetic material 106 and on surfaces of the core 102 to form one or more PTH 109 in the core 102. In some embodiments, a conductive seed layer (not shown) precedes conductive layer formation 108. The conductive seed layer may comprise a suitable metal film comprising any of copper, nickel, gold, silver, tungsten, ruthenium or molybdenum and have a thickness ranging from 100 nanometers (nm) to several microns. A conductive layer may be deposited over a seed layer. In some embodiments, the core 102 may be immersed in a plating bath within a plating cell. The conductive layer 108 may comprise metals suitable for electrodeposition, such as, but not limited to, copper, silver, gold, nickel, aluminum or tungsten. Techniques other than electroplating may be employed to form the conductive layer 108 according to the particular application.

In FIG. 4F a non-magnetic material, which may comprise a dielectric material in an embodiment, may be formed within the openings 109 on sidewalls of the conductive liner 108 using process 164, for example. The non-magnetic material 110 may fill the opening 109 in an embodiment and may comprise any suitable dielectric material. In FIG. 4G, first and second conductive pads 116, 116′ may be formed on the conductive liner portions 108a, 108b respectively to form coupled coaxial inductor structures 104. In an embodiment, a first pad 116a may be formed on a first portion of the conductive liner 108a, and a second pad 116b may be formed on a second portion of the conductive liner 108b, wherein there is a distance 114 between the first and second pads 116a, 116b.

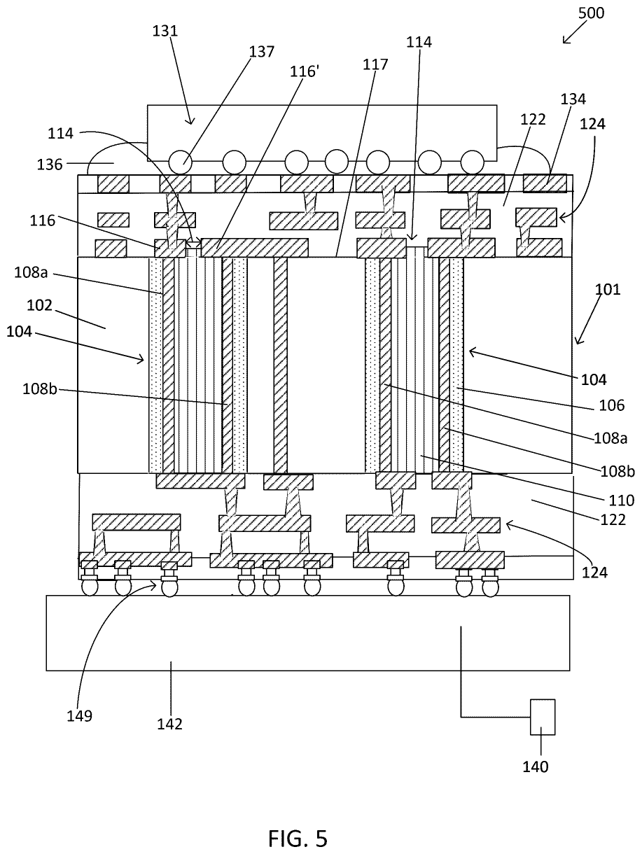

FIG. 5 depicts an IC package structure 500, such as package structure including inductor structures according to embodiments herein. The package structure 500 may be similar to the package structure depicted in FIG. 1A for example, wherein one or more coupled CMIL inductor structures 104 are within core 102, and wherein inductor structures 104 are coupled to die 131 through conductive traces 124 within the package substrate 101. In some embodiments, the die 131 may comprise chiplet structures which may comprise components of a system on a chip (SOC) structure. In an embodiment the package substrate 101 may include an interposer.

Any number of die/devices 131 may be coupled to the package substrate 101. The package substrate 101 may be coupled to a board 142, such as a printed circuit board, in an embodiment. The board 142 may be coupled to the package substrate 101 through solder structures 149 in an embodiment. A power supply 140, which may comprise any suitable power supply as known in the art, may be coupled to die 131 via IC package substrate 101, in an embodiment. The inductors 104 may comprise coupled CMIL inductors, with a first pad 116 on a first portion 108a of the conductive liner 108 and a second pad 116′ on a second portion 108b of the conductive liner 108 separated by a distance 114, as depicted in FIG. 4G, for example. Solder interconnect structures 137 may couple the die 131 to the substrate 101. An underfill material 136 may surround the solder structures 137, in an embodiment.

Discussion now turns to operations for assembling and/or fabricating the discussed structures.

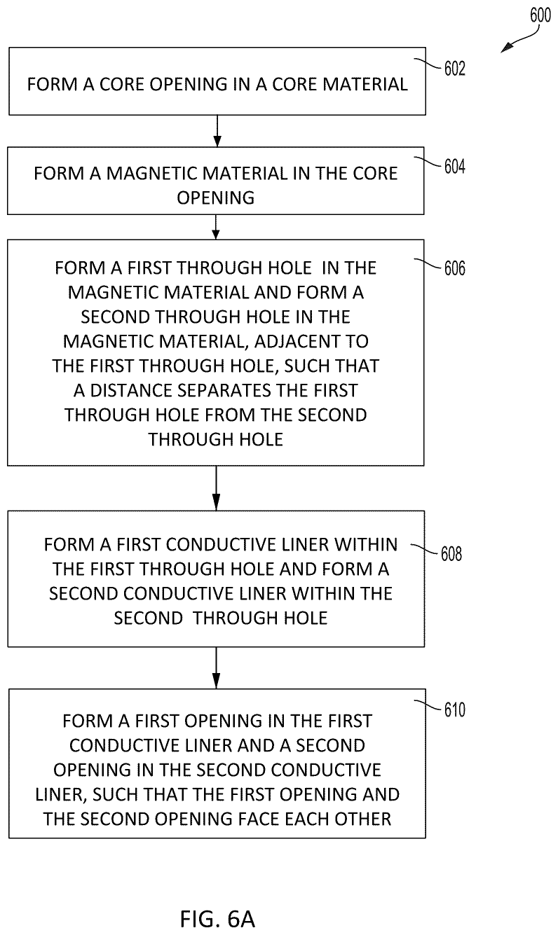

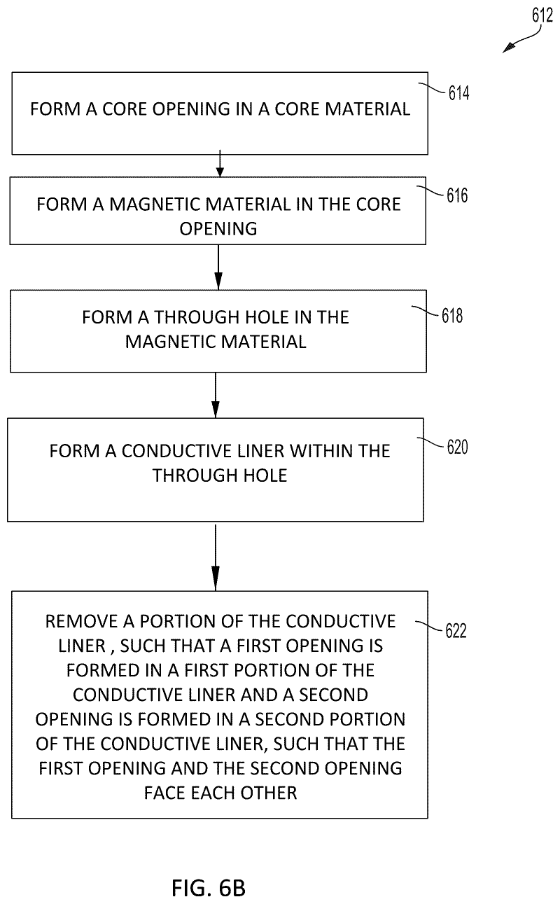

FIG. 6A is a flow chart of a process 600 of fabricating package structures, such as a coupled CMIL inductor within a core, according to some embodiments. For example, process 600 may be used to fabricate any of the microelectronic IC package structures of FIGS. 2A-2I.

As set forth in block 602, a core opening may be formed in a core material. The core material may provide a rigid mechanical support for the fabrication of a package substrate (e.g., package substrate 101), formed by lamination of dielectric layers and of metallization structures. In some embodiments, the core comprises materials such as, but not limited to, fiberglass-reinforced epoxy resins, glass, or polymer-ceramic composites. The core opening may be formed by a drilling process followed by a cleaning process, in an embodiment. In an embodiment, the core opening may comprise a through hole opening. In an embodiment, the core opening is formed through an entire length of the core.

As set forth in block 604, a magnetic material may be formed in the core opening. The magnetic material may be formed to completely fill the core opening in an embodiment. The magnetic material may comprise any suitable magnetic materials, as are known in the art, such as any suitable magnetic paste material, in an embodiment. The magnetic material may be formed by plugging the core opening with a magnetic paste, for example. In an embodiment, the magnetic paste may comprise an iron powder such as iron oxide powder, such as Mg—Zn-based ferrite, Fe—Mn-based ferrite, Mn—Zn-based ferrite, Mn—Mg-based ferrite, Cu—Zn-based ferrite, Mg—Mn—Sr-based ferrite, Ni—Zn-based ferrite, Ba—Zn-based ferrite, Ba-Mgbased ferrite, Ba—Ni-based ferrite, Ba—Co-based ferrite, Ba—Ni—Co-based ferrite, Y-based ferrite, ferric oxide powder (III), or triiron tetraoxide, iron alloy-based metal powder, such as Fe—Si-based alloy powder, Fe—Si—Al-based alloy powder, Fe—Cr-based alloy powder, Fe—Cr—Si-based alloy powder, Fe—Ni—Cr-based alloy powder, Fe—Cr—Al-based alloy powder, Fe—Ni-based alloy powder, Fe—Ni—Mo-based alloy powder, Fe—Ni—Mo—Cu-based alloy powder, Fe—Co-based alloy powder, or Fe—Ni—Co-based alloy powder or amorphous alloys, such as a Co-group amorphous alloys.

The magnetic paste may further comprise an epoxy resin such as a bisphenol A epoxy resin; a bisphenol F epoxy resin; a bisphenol S epoxy resin; a bisphenol AF epoxy resin, a dicyclopentadiene epoxy resin, a trisphenol epoxy resin, a phenol novolac epoxy resin, a tert-butyl-catechol epoxy resin, epoxy resins having a condensed ring structure, such as a naphthol novolac epoxy resin, a naphthalene epoxy resin, a naphthol epoxy resin, or an anthracene epoxy resin, a glycidyl amine epoxy resin, a glycidyl ester epoxy resin, a cresol novolac epoxy resin, a biphenyl epoxy resin, a linear aliphatic epoxy resin, an epoxy resin having a butadiene structure, an alicyclic epoxy resin, a heterocyclic epoxy resin, a spiro ring-containing epoxy resin, a cyclohexane dimethanol epoxy resin, a trimethylol epoxy resin or a tetraphenyl ethane epoxy resin. The magnetic paste may further comprise a dispersant such as a phosphate-based dispersant, a curing agent or a curing accelerator.

At block 606, a first through hole (TH) opening may be formed in the magnetic material and a second TH opening may be formed in the magnetic material, adjacent to the first TH opening, wherein a distance separates the first TH opening from the second TH opening. In an embodiment, the first and second TH openings may comprise second through holes through the core and magnetic material within the core. The first and second TH openings extend through the entire core. The first and the second TH openings can be formed by utilizing a drilling process in an embodiment. The first and second TH openings may comprise circular shapes, in an embodiment.

At block 608, a first conductive liner may be formed within the first TH opening and a second conductive liner may be formed within the second TH opening. In an embodiment, the first and second conductive liners are formed on sidewalls of the magnetic material within the first and second TH openings respectively. In an embodiment, the conductive liner material may comprise any suitable conductive materials such as copper and copper alloys. In an embodiment, the conductive material of the first and second conductive liners may be formed utilizing an electroplating process and may comprise a thickness of between about 15 microns to about 30 microns, wherein an opening remains within the first and second TH openings. In an embodiment, a distance between an outer sidewall of the first and second conductive liners and an outer sidewall of the magnetic material comprises between about 140 microns and about 160 microns.

At block 610 a first opening in the first conductive liner and a second opening in the second conductive liner may be formed, wherein the first opening and the second opening face each other. In an embodiment, the first and second openings in the conductive liner are formed by forming a groove between the first and second conductive liners. The groove may be formed by utilizing a routing process, across an X axis direction as viewed from a top view, in an embodiment. The routing process may comprise an engraving process in an embodiment, and can be performed utilizing micro-broaching drill pits, in an embodiment. In an embodiment, the groove between the first and second openings in first and second conductive liners may comprise a width of about 80 microns to about 120 microns between a first portion of the conductive liner and a second portion of the conductive liner. First and second conductive pads may be formed on top surfaces of the first and second portions of the conductive liner, respectively.

A build up layer may be subsequently formed on the core, and one or more die may be attached on the build-up layer to form a package structure as shown in FIG. 1A for example. The die may comprise a central processing unit (CPU) or a field programmable gate array (FPGA) die, for example or may comprise any suitable logic die for the particular application. The die may be attached utilizing any suitable die attach process, as are known in the art.

By removing a portion of the conductive liner between the two conductive liners, two semicircular or semi-oval portions of the conductive liner are formed and separated by a distance, which is the groove width. By creating a groove between the two semicircular portions of the conductive liner, the need for a third through hole drilling and plugging step is eliminated. Additionally, mis-alignment risks and fabrication costs are reduced. The embodiments herein result in tighter through hole wall to wall distance (less than 100 um) which produce a stronger magnetic coupling for the coupled CMIL inductors described according to the embodiments of the present disclosure.

FIG. 6B is a flow chart of a process 612 of fabricating package structures, such as a coupled CMIL inductor within a core, according to some embodiments. For example, process 612 may be used to fabricate any of the microelectronic IC package structures of FIGS. 3A-3H.

As set forth in block 614, a core opening is formed in a core material. The core material may comprise metallization structures separated by laminated dielectric layers. In some embodiments, the core comprises materials such as, but not limited to, fiberglass-reinforced epoxy resins, glass, or polymer-ceramic composites. The core opening may be formed by a drilling process followed by a cleaning process, in an embodiment. In an embodiment, the core opening is formed through an entire length of the core. The core opening may comprise a through hole in an embodiment.

As set forth in block 616, a magnetic material may be formed in the core opening, wherein the magnetic material may comprise any suitable composition as previously described herein and may comprise a magnetic paste in an embodiment. A thickness of the magnetic material may be from about 10 microns to about 200 microns as measured from the core to the conductive liner, in an embodiment.

As set forth in block 618, a TH opening may be formed in the magnetic material. The TH opening may comprise an oval shape as viewed from a plan view, in an embodiment.

As set forth in block 620, a conductive liner may be formed within the TH opening. The conductive liner material may comprise any suitable conductive materials such as copper and/or copper alloys. In an embodiment, the conductive material may be formed utilizing an electroplating process and may comprise a thickness of between about 15 microns to about 30 microns. The TH opening with the conductive liner may comprise a PTH in an embodiment.

As set forth in block 622, a portion of the conductive liner may be removed, wherein a first opening is formed in a first portion of the conductive liner and a second opening is formed in a second portion of the conductive liner, wherein the first opening and the second opening face each other. The portion of the conductive liner may be removed in a central portion of the conductive liner, wherein a groove is formed between the first portion and the second portion of the conductive liner. In an embodiment, the groove may be formed by utilizing a routing process, across a Y axis direction as viewed from a top view, in an embodiment. The routing process may comprise an engraving process in an embodiment, and can be performed utilizing micro-broaching drill pits, in an embodiment.

A build up layer may be subsequently formed on the core, and one or more die may be attached on the build-up layer to form a package structure as shown in FIG. 1A for example. The die may comprise a central processing unit (CPU) or a field programmable gate array (FPGA) die, for example or may comprise any suitable logic die for the particular application. The die may be attached utilizing any suitable die attach process, as are known in the art.

By removing a portion of the conductive liner in a middle portion of the PTH, two semicircular portions of the conductive liner are formed and are separated by a distance, which is the groove width. By creating a groove between the two semicircular portions of the conductive liner, the need for a third through hole drilling and plugging step is eliminated. Additionally, mis-alignment risks and fabrication costs are reduced.

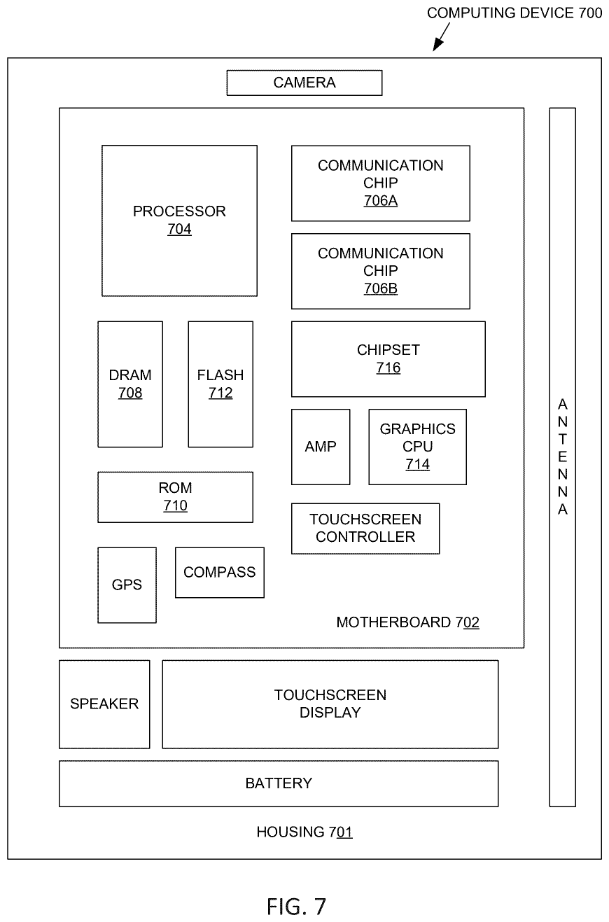

FIG. 7 illustrates an electronic or computing device 700 in accordance with one or more implementations of the present description. The computing device 700 may include a housing 701 having a board 702 disposed therein. The computing device 700 may include a number of integrated circuit components, including but not limited to a processor 704, at least one communication chip 706A, 706B, volatile memory 708 (e.g., DRAM), non-volatile memory 710 (e.g., ROM), flash memory 712, a graphics processor or CPU 714, a digital signal processor (not shown), a crypto processor (not shown), a chipset 716, an antenna, a display (touchscreen display), a touchscreen controller, a battery, an audio codec (not shown), a video codec (not shown), a power amplifier (AMP), a global positioning system (GPS) device, a compass, an accelerometer (not shown), a gyroscope (not shown), a speaker, a camera, and a mass storage device (not shown) (such as hard disk drive, compact disk (CD), digital versatile disk (DVD), and so forth). Any of the integrated circuit components may be physically and electrically coupled to the board 702. In some implementations, at least one of the integrated circuit components may be a part of the processor 704.

The communication chip enables wireless communications for the transfer of data to and from the computing device. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device may include a plurality of communication chips. For instance, a first communication chip may be dedicated to shorter range wireless communications such as Wi-Fi and Bluetooth and a second communication chip may be dedicated to longer range wireless communications such as GPS, EDGE, GPRS, CDMA, WiMAX, LTE, Ev-DO, and others.

The term “processor” may refer to any device or portion of a device that processes electronic data from registers and/or memory to transform that electronic data into other electronic data that may be stored in registers and/or memory. At least one of the integrated circuit components may include a package structure with a coupled CMIL as described in any of the embodiments herein.

In various implementations, the computing device may be a laptop, a netbook, a notebook, an ultrabook, a smartphone, a tablet, a personal digital assistant (PDA), an ultra-mobile PC, a mobile phone, a desktop computer, a server, a printer, a scanner, a monitor, a set-top box, an entertainment control unit, a digital camera, a portable music player, or a digital video recorder. In further implementations, the computing device may be any other electronic device that processes data.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure. It is understood that the subject matter of the present description is not necessarily limited to specific applications illustrated in FIGS. 1-7. The subject matter may be applied to other integrated circuit devices and assembly applications, as well as any appropriate electronic application, as will be understood to those skilled in the art.

The following examples pertain to further embodiments and specifics in the examples may be used anywhere in one or more embodiments, wherein a first example is an apparatus, comprising a package substrate having two or more conductive layers separated by a dielectric material, a core on the dielectric material, and an inductor having a length extending vertically through the core, the inductor comprising, a magnetic material on a sidewall of the core, a first portion of a conductive liner on an inner sidewall of the magnetic material, a second portion of the conductive liner on the inner sidewall of the magnetic material, opposite the first portion of the conductive liner, wherein the first portion of the conductive liner and the second portion of the conductive liner are separated by a non-magnetic material, a first conductive pad on a top surface of the core coupled to the first portion of the conductive liner, and a second conductive pad on the top surface of the core coupled to the second portion of the conductive liner, wherein a distance is between the first conductive pad and the second conductive pad.

In second examples, the first example further comprises wherein the distance is between 40 microns and 80 microns, and wherein the inductor comprises a coupled coaxial magnetic inductor.

In third examples, wherein any one of examples 1-2 further comprises wherein the distance comprises a gap, and wherein the dielectric material is within the gap.

In fourth examples, wherein any one of examples 1-3 further comprises wherein the non-magnetic material is on an inner sidewall of the first portion of the conductive liner and is on an inner sidewall of the second portion of the conductive liner, and wherein the non-magnetic material comprises at least one of a composite epoxy material, silica or inorganic fillers.

In fifth examples, wherein any one of examples 1-4 further comprises wherein the distance comprises a gap, and wherein the dielectric material is within the gap.

In sixth examples, wherein any one of examples 1-5 further comprises wherein the first portion of the conductive liner comprises a first portion terminal sidewall, and the second portion of the conductive liner comprises a second portion terminal sidewall, wherein a portion of the non-magnetic material is on the first portion terminal sidewall and is on the second portion terminal sidewall.

In seventh examples, wherein any one of examples 1-6 further comprises wherein a portion of the first portion of the conductive liner that is in a plane orthogonal to the length of the inductor comprises a first opening, and a portion of the second portion of the conductive liner that is in the plane comprises a second opening, wherein the first opening and the second opening face each other in the plane.

In eighth examples, wherein example 7 further comprises wherein a distance between the first opening and the second opening comprises between 50 microns and 100 microns.

In ninth examples, wherein any one of examples 1-8 further comprises wherein the first portion of the conductive liner comprises an outer sidewall wherein a portion of the non-magnetic material between the first portion of the conductive liner and the second portion of the conductive liner extends beyond the outer sidewall.

In tenth examples, wherein any one of examples 1-9 further comprises wherein the non-magnetic material between the first portion of the conductive liner and the second portion of the conductive liner does not extend beyond the outer sidewall of the first portion of the conductive liner.

In eleventh examples, wherein any one of examples 1-10 further comprises wherein a width of the magnetic material comprises between 100 microns to 160 microns and a distance between outer sidewalls of the second portion of the conductive liner comprises between 100 microns to 160 microns.

A twelfth example is an apparatus comprising a package substrate comprising a core, an inductor having a length extending vertically through the core, the inductor comprising a magnetic material on a sidewall of the core, a first conductive liner on a sidewall of the magnetic material, wherein a portion of the first conductive liner that is in a plane orthogonal to the length of the inductor comprises a first opening; and a second conductive liner on the sidewall of the magnetic material, wherein a portion of the second conductive liner that is in the plane comprises a second opening, wherein the first opening and the second opening face each other and are separated by a distance.

In thirteenth examples, wherein example twelve further comprises wherein a non-magnetic material is between the first opening and the second opening, wherein the first conductive liner comprises an outer sidewall and the second conductive liner comprise an outer sidewall wherein a portion of the non-magnetic material extends beyond the outer sidewalls of the first and second conductive liners.

In fourteenth examples, wherein any one of examples 12-13 further comprises wherein a portion of the non-magnetic material does not extend beyond the outer sidewall of the first conductive liner, and wherein the first and second conductive liners comprise a semi-circle shape or a half oval shape in the plane.

In fifteenth examples, wherein any one of examples 12-14 further comprises wherein the magnetic material comprises at least one of iron, iron, nickel, cobalt, manganese, samarium, ytterbium, gadolinium, terbium, or dysprosium.

In sixteenth examples, wherein any one of examples 12-15 further comprises wherein the first conductive liner and the second conductive liner comprise copper or copper alloys, and wherein a die is coupled to the inductor and a power supply is coupled to the die.

In seventeenth examples, wherein any one of examples 12-16 further comprises wherein a distance between an outer sidewall of the magnetic material and an outer sidewall of the first conductive liner is about 150 microns or less, and wherein a wall to wall pitch between inner sidewalls of the first and second conductive liners is 100 microns or less.

An eighteenth example is a method comprising forming a core opening in a core material, forming a magnetic material in the core opening, forming a first through hole (TH) in the magnetic material and forming a second TH in the magnetic material, adjacent to the first TH, wherein a distance separates the first TH from the second TH, forming a first conductive liner within the first TH and forming a second conductive liner within the second TH and forming a first opening in the first conductive liner and a second opening in the second conductive liner, wherein the first opening and the second opening face each other.

In nineteenth examples, wherein any one of example eighteen further comprises forming a non-magnetic material on an inner surface of the first conductive liner and on an inner surface of the second conductive liner.

In twentieth examples, wherein any one of examples 18-19 further comprises wherein forming the first opening in the first conductive liner and the second opening in the second conductive liner comprises removing a portion of the first conductive liner and removing a portion of the second conductive liner by using a routing process.

It will be recognized that principles of the disclosure are not limited to the embodiments so described but can be practiced with modification and alteration without departing from the scope of the appended claims. The above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

What is claimed is:

1. An apparatus, comprising:
a package substrate comprising two or more conductive layers separated by a dielectric material;
a core on the dielectric material; and
an inductor having a length extending vertically through the core, the inductor comprising:
a magnetic material on a sidewall of the core;
a first portion of a conductive liner on an inner sidewall of the magnetic material;
a second portion of the conductive liner on the inner sidewall of the magnetic material, opposite the first portion of the conductive liner, wherein the first portion of the conductive liner and the second portion of the conductive liner are separated by a non-magnetic material;
a first conductive pad on a top surface of the core coupled to the first portion of the conductive liner; and
a second conductive pad on the top surface of the core coupled to the second portion of the conductive liner, wherein a distance is between the first conductive pad and the second conductive pad.

2. The apparatus of claim 1, wherein the distance is between 40 microns and 80 microns, and wherein the inductor comprises a coupled coaxial magnetic inductor.

3. The apparatus of claim 1, wherein the distance comprises a gap, and wherein the dielectric material is within the gap.

4. The apparatus of claim 1, wherein the non-magnetic material is on an inner sidewall of the first portion of the conductive liner and is on an inner sidewall of the second portion of the conductive liner, and wherein the non-magnetic material comprises at least one of a composite epoxy material, silica or inorganic fillers.

5. The apparatus of claim 1, wherein the first portion of the conductive liner comprises a first portion terminal sidewall, and the second portion of the conductive liner comprises a second portion terminal sidewall, wherein a portion of the non-magnetic material is on the first portion terminal sidewall and is on the second portion terminal sidewall.

6. The apparatus of claim 1, wherein the non-magnetic material comprises a different material than the dielectric material, and wherein the non-magnetic material comprises a width of between 80 microns and 150 microns.

7. The apparatus of claim 1, wherein a portion of the first portion of the conductive liner that is in a plane orthogonal to the length of the inductor comprises a first opening, and a portion of the second portion of the conductive liner that is in the plane comprises a second opening, wherein the first opening and the second opening face each other in the plane.

8. The apparatus of claim 7, wherein a distance between the first opening and the second opening comprises between 50 microns and 100 microns.

9. The apparatus of claim 1, wherein the first portion of the conductive liner comprises an outer sidewall wherein a portion of the non-magnetic material between the first portion of the conductive liner and the second portion of the conductive liner extends beyond the outer sidewall.

10. The apparatus of claim 9, wherein the non-magnetic material between the first portion of the conductive liner and the second portion of the conductive liner does not extend beyond the outer sidewall of the first portion of the conductive liner.

11. The apparatus of claim 1, wherein a width of the magnetic material comprises between 100 microns to 160 microns and a distance between outer sidewalls of the second portion of the conductive liner comprises between 100 microns to 160 microns.

12. An apparatus, comprising:
a package substrate comprising a core;
an inductor having a length extending vertically through the core, the inductor comprising:
a magnetic material on a sidewall of the core;
a first conductive liner on a sidewall of the magnetic material, wherein a portion of the first conductive liner that is in a plane orthogonal to the length of the inductor comprises a first opening; and
a second conductive liner on the sidewall of the magnetic material, wherein a portion of the second conductive liner that is in the plane comprises a second opening, wherein the first opening and the second opening face each other and are separated by a distance.

13. The apparatus of claim 12, wherein a non-magnetic material is between the first opening and the second opening, wherein the first conductive liner comprises an outer sidewall and the second conductive liner comprise an outer sidewall wherein a portion of the non-magnetic material extends beyond the outer sidewalls of the first and second conductive liners.

14. The apparatus of claim 13, wherein a portion of the non-magnetic material does not extend beyond the outer sidewall of the first conductive liner, and wherein the first and second conductive liners comprise a semi-circle shape or a half oval shape in the plane.

15. The apparatus of claim 12, wherein the magnetic material comprises at least one of iron, iron, nickel, cobalt, manganese, samarium, ytterbium, gadolinium, terbium, or dysprosium.

16. The apparatus of claim 12, wherein the first conductive liner and the second conductive liner comprise copper or copper alloys, and wherein a die is coupled to the inductor and a power supply is coupled to the die.

17. The apparatus of claim 12, wherein a distance between an outer sidewall of the magnetic material and an outer sidewall of the first conductive liner is about 150 microns or less, and wherein a wall to wall pitch between inner sidewalls of the first and second conductive liners is 100 microns or less.

18. A method, comprising:
forming a core opening in a core material;
forming a magnetic material in the core opening;
forming a first through hole (TH) in the magnetic material and forming a second TH in the magnetic material, adjacent to the first TH, wherein a distance separates the first TH from the second TH;
forming a first conductive liner within the first TH and forming a second conductive liner within the second TH; and
forming a first opening in the first conductive liner and a second opening in the second conductive liner, wherein the first opening and the second opening face each other.

19. The method of claim 18, further comprising forming a non-magnetic material on an inner surface of the first conductive liner and on an inner surface of the second conductive liner.

20. The method of claim 18, wherein forming the first opening in the first conductive liner and the second opening in the second conductive liner comprises removing a portion of the first conductive liner and removing a portion of the second conductive liner by using a routing process.
